(19) United States
(12) Patent Application Publication
(10) Pub. No.: US 2019/0187955 A1
(43) Pub. Date: Jun. 20, 2019

(54) SYSTEMS AND METHODS FOR COMMENT RANKING USING NEURAL EMBEDDINGS

(71) Applicant: Facebook, Inc., Menlo Park, CA (US)

(72) Inventor: Bradley Ray Green, Snohomish, WA (US)

(21) Appl. No.: 15/844,061

(22) Filed: Dec. 15, 2017

(51) Int. Cl. G06F 7/24; G06F 17/30; G06N 3/08; G06N 3/04; G06F 17/24; G06F 17/28

(52) U.S. Cl. CPC G06F 7/24; G06F 17/3089; G06F 17/28; G06N 3/04; G06F 17/24; G06N 3/08

(57) ABSTRACT

Systems, methods, and non-transitory computer readable media are configured to generate, an embedding for a post. The post can correspond to an entity. An embedding for a comment in a set of comments can be generated. The comments in the set can be responsive to the post. The embedding for the post can be updated. The updating can be based on the embedding for the post and the embedding for the comment. Subsequently, a rank for the comment in the set of comments can be determined.

### FIELD OF THE INVENTION

The present technology relates to the field of machine learning in a social networking system. More particularly, the present technology relates to techniques for ranking comments for presentation using machine learning.

### BACKGROUND

Within a social networking system, a post can be made to an entity. As examples, the entity can be a page, a group, or an event. The post can include media content items and text. A comment can be employed to respond to the post. Like the post, the comment can include media content items and text. Moreover, a comment can be used to respond to another comment. As such, by way of comments, posts can spark interaction between users of the social networking system.

### SUMMARY

Various embodiments of the present disclosure can include systems, methods, and non-transitory computer readable media configured to generate an embedding for a post. The post can correspond to an entity. An embedding for a comment in a set of comments can be generated. The comments in the set can be responsive to the post. The embedding for the post can be updated. The updating can be based on the embedding for the post and the embedding for the comment. Subsequently, a rank for the comment in the set of comments can be determined.

In an embodiment, a relevancy score for the comment can be determined. The relevancy score can be based on the embedding for the post and the embedding for the comment. The rank for the comment can be determined based at least in part on the relevancy score.

In an embodiment, a personalization score for the comment can be determined. The personalization score can be based on the embedding for the post, an embedding for a user to whom the post is to be presented, and the embedding for the comment. The rank for the comment can be determined based at least in part on the personalization score.

In an embodiment, the embedding for the post can be generated based on an embedding for a user who has made the post, embeddings for words in the post, and embeddings for media content items in the post.

In an embodiment, the embedding for the comment can be generated based on an embedding for a user who has made the comment, embeddings for words of the comment, and embeddings for media content items of the comment.

In an embodiment, an embedding for a user can be generated. The embedding for the user can be generated based at least in part on embeddings for entities with which the user has interacted.

In an embodiment, generating the embedding for the user can include generating a paragraph embedding.

In an embodiment, an embedding for the entity can be generated. In particular, the embedding for the entity can be generated based at least in part on embeddings for words of posts and comments of the entity, and embeddings for media content items of posts and comments of the entity.

In an embodiment, determining the rank for the comment can comprise determining a cosine similarity.

In an embodiment, a media content item can be provided to a machine learning model. A prediction of words appearing with the media content item can be received from the machine learning model. An embedding for the media content item can be generated. In particular, the embedding for the media content item can be generated based at least in part on embeddings for the predicted words.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example comment ranking module, according to an embodiment of the present disclosure.

FIG. 2 illustrates an example of an engagement embeddings module, according to an embodiment of the present disclosure.

FIG. 3 illustrates an example of a remark embeddings module, according to an embodiment of the present disclosure.

FIG. 4 illustrates an example functional block diagram, according to an embodiment of the present disclosure.

FIG. 5 illustrates an example process, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Comment Ranking Using Neural Embeddings

Within a social networking system, a post can be made to an entity. As examples, the entity can be a page, a group, or an event. The post can include media content items and text. A comment can be employed to respond to the post. Like the post, the comment can include media content items and text. Moreover, a comment can be used to respond to another comment. As such, by way of comments, posts can spark interaction between users of the social networking system.

A user of a social networking system can access a dedicated location or representation of an entity on the social networking system. This can cause posts and comments of the entity to be presented to the user. When presenting a given post, one possibility is to present all of the comments for that post to the user. However, this can lead to a poor experience for the user. A popular entity can attract numerous comments to its posts. To display all of these comments to the user could overwhelm the user. Because of this, the social networking system can display to the user only some of the comments. A number conventional approaches exist for selecting which of the comments may be displayed to the user. For example, n comments can be selected for display, with the social networking system selecting the n newest comments. As another example, v comments can be selected for display, with the social networking system selecting the v comments which have received the most views. While approaches such as these may prevent the user from being overwhelmed by a large quantity of comments, the experience of the user can nevertheless be unsatisfying. For example, selecting comments for display based on newness or quantity of views does not necessarily ensure that selected comments are relevant to the user. As another example, selecting comments for display based on newness or quantity of views does not necessarily ensure that selected comments are relevant to their corresponding posts. Accordingly, such conventional approaches may not be effective in addressing these and other problems arising in computer technology.

An improved approach overcomes the foregoing and other disadvantages associated with conventional approaches. In various embodiments, the disclosed technology can utilize neural embeddings in selecting comments to be displayed to a user of a social networking system. For example, in some embodiments, a first user can make a post to an entity of the social networking system. An embedding can be generated for the post. A second user can make a comment in reply to the post. An embedding can be generated for the comment. The embedding for the post can then be updated based on the embedding for the comment. Additional users can make comments in reply to the post. An embedding can be generated for each of these comments. The embedding for the post can again be updated based on the embeddings for these comments. Subsequently, a different user might access the entity. This can cause the post and the comments of the entity to be displayed to the different user. The comments of the post can then be ranked by the social networking system. As one example, the ranking of the comments can be personalized for the different user. In this example, the ranking can include calculating a personalization score for each comment. The calculation of the personalization score for a given comment can include calculating a cosine similarity between: (1) the embedding for the post and an embedding for the different user and (2) an embedding for the comment. As another example, comments can be ranked based on their relevancy to the post. In this example, the ranking of the comments can include calculating a relevancy score for each comment that reflects a level of relevance of the comment to the post. The calculation of the relevancy score for a given comment can include calculating a cosine similarity between the embedding for the post and an embedding for the comment. The post and the comments can then be displayed to the different user. The comments can be displayed in an order which reflects the calculated personalization scores or the calculated relevancy scores. More details regarding the discussed technology are provided herein.

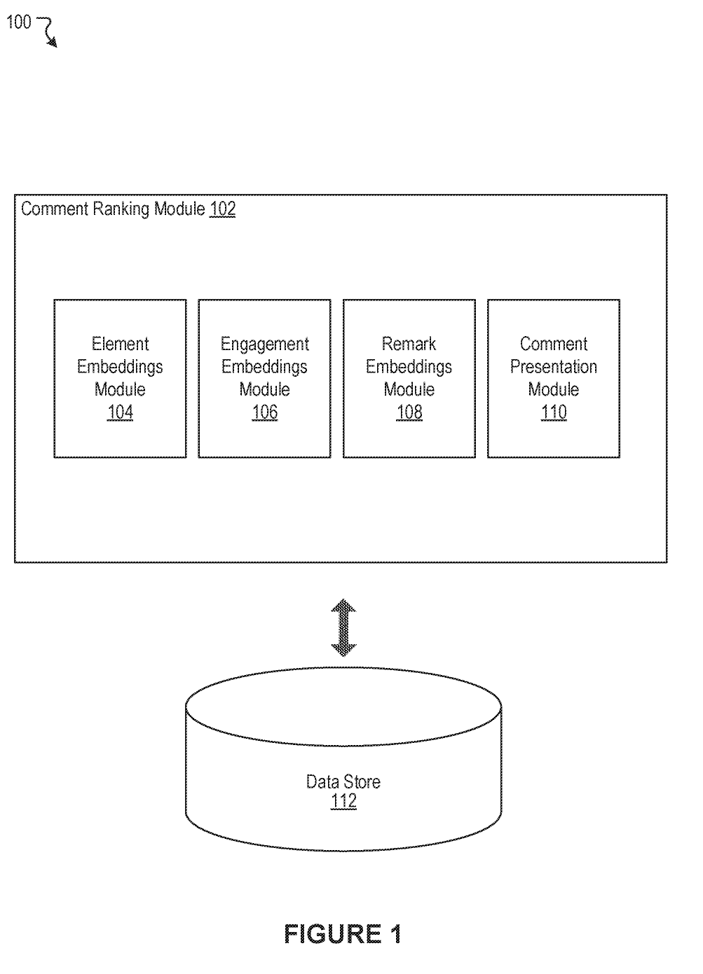

FIG. 1 illustrates an example system 100 including an example comment ranking module 102, according to an embodiment of the present disclosure. As shown in the example of FIG. 1, the comment ranking module 102 can include an element embeddings module 104, an engagement embeddings module 106, a remark embeddings module 108, and a comment presentation module 110. In some instances, the example system 100 can include at least one data store 112. The components (e.g., modules, elements, etc.) shown in this figure and all figures herein are exemplary only, and other implementations can include additional, fewer, integrated, or different components. Some components may not be shown so as not to obscure relevant details. In some embodiments, the comment ranking module 102 can be implemented in a system, such as a social networking system. While the disclosed technology may be described herein in connection with a social networking system for illustrative purposes, the disclosed technology can be implemented in any other type of system or environment.

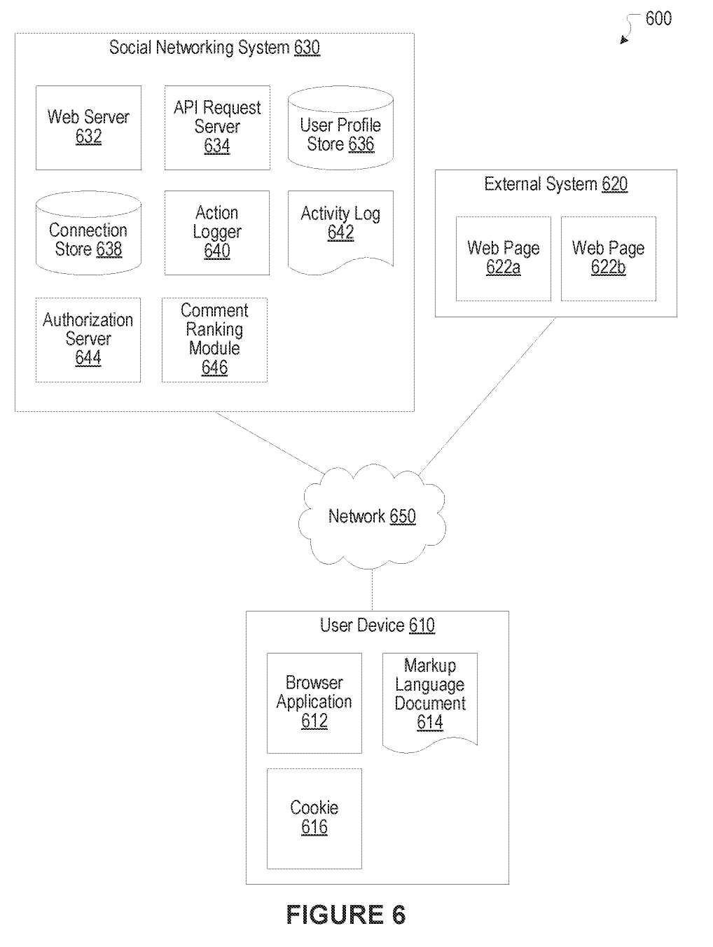

In some embodiments, the comment ranking module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the comment ranking module 102 can be implemented, in part or in whole, as software running on one or more computing devices or systems. For example, the comment ranking module 102 or at least a portion thereof can be implemented using one or more computing devices or systems that include one or more servers, such as network servers or cloud servers. In another example, the comment ranking module 102 or at least a portion thereof can be implemented as or within an application (e.g., app), a program, an applet, or an operating system, etc., running on a user computing device or a client computing system, such as a user computing device 610 of FIG. 6. In some instances, the comment ranking module 102 can, in part or in whole, be implemented within or configured to operate in conjunction with a system (or service), such as a social networking system 630 of FIG. 6. It should be understood that there can be many variations or other possibilities.

The comment ranking module 102 can be configured to communicate and/or operate with the at least one data store 112, as shown in the example system 100. The data store 112 can be configured to store and maintain various types of data. For example, the data store 112 can store information describing various embeddings, personalization scores, relevancy scores, and rankings. In some implementations, the data store 112 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the data store 112 can store information associated with users, such as user identifiers, user information, profile information, user specified settings, content produced or posted by users, and various other types of user data.

The element embeddings module 104 can generate a natural language embedding for each unique word of a corpus. The corpus can include both curated text and text which appears organically within the social networking system. As an example, the curated text can be some or all of the text of an encyclopedia. The text which appears organically within the social networking system can be, as an example, the text of some or all of the posts and/or comments of the social networking system. The posts and/or comments can correspond to pages, groups, and/or events of the social networking system. In some embodiments, the element embeddings module 104 can generate the natural language embeddings using a skip-gram model, a continuous bag-of-words (CBOW) model, or any generally known approach for creating word embeddings. As one illustration, word2vec can be used. After generating respective natural language embeddings for words of the corpus, the element embeddings module 104 can save the embeddings in the data store 112. Later, the element embeddings module 104 can receive a request for an embedding for a word. The element embeddings module 104 can retrieve the natural language embedding which has been generated for the word from the data store 112 and can satisfy the request by replying with the natural language embedding.

In some embodiments, the element embeddings module 104 can use a trained machine learning model to predict words which may be expected to appear with a media content item, for example, in a post or comment. In various embodiments, the machine learning model can apply a deep neural network. The machine learning model can be trained by receiving instances of training data. Each instance of training data can include, as training data input, a media content item from a post or comment introduced to the social networking system. The instance of training data can include, as training data output, words which appear in text of the post or comment. Media content items can include images and videos. Where the training data input corresponds to a video, the training data input can be a still (e.g., frame) of the video.

Once the machine learning model has been trained, the element embeddings module 104 can receive a request for an embedding for a media content item. The media content item can be from a post or comment introduced to the social networking system. The element embeddings module 104 can provide the media content item as input to the machine learning model. Where the media content item is a video, the input can be a still (e.g., frame) of the video. The element embeddings module 104 can receive from the machine learning model an output which results from the input. The output can be a prediction of words which may be expected to appear with the media content item in a post or comment. In some embodiments, for each predicted word, the element embeddings module 104 can retrieve a natural language embedding which has been generated for the word. This natural language embedding may be obtained from the data store 112, for example. The element embeddings module 104 can use such natural language embeddings to generate an embedding for the media content item. The use of the natural language embeddings can cause the generated embedding for the media content item to exist within the same vector space as the natural language embeddings. As an example, the embedding for the media content item can be generated as follows:

π′(m)=γ_{pw}·Σ_{pwϵmi}π(pw),

where π′(m) corresponds to the embedding for the media content item, γ_{pw} corresponds a weight, π(pw) corresponds the natural language embedding for a given one of the predicted words, and Σ_{pwϵmi} indicates that a summation be performed over natural language embeddings for all of the predicted words. In some embodiments, the weight can be selected using a machine learning model. There can be many variations or other possibilities.

After generating the embedding for the media content item, the element embeddings module 104 can return the embedding to a requestor of the embedding. In some embodiments, the element embeddings module 104 can save the embedding for the media content item in the data store 112. In these embodiments, when receiving a request for an embedding for a media content item, the element embeddings module 104 can check the data store 112 to determine whether an embedding for the media content item already exists. Where an embedding for the media content item does not already exist, the element embeddings module 104 can generate an embedding for the media content item. Where an embedding does already exist for the media content item, the element embeddings module 104 can retrieve the embedding for the media content item from the data store 112.

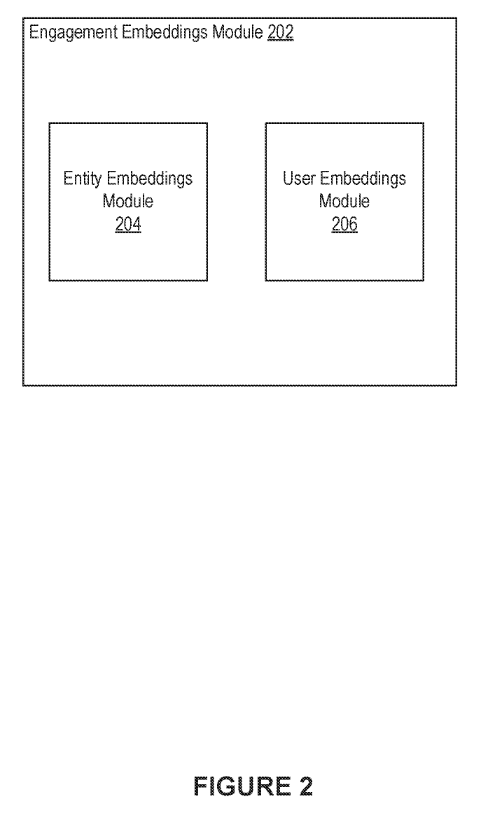

The engagement embeddings module 106 can determine and provide embeddings corresponding to entities. As mentioned, entities can include any interface through which comments can be posted, including, for example, pages, groups, and events that are accessible through the social networking system. Similarly, the engagement embeddings module 106 can determine and provide embeddings corresponding to users. Users can include users of the social networking system, for example. Additional details regarding the engagement embeddings module 106 are provided below with reference to FIG. 2.

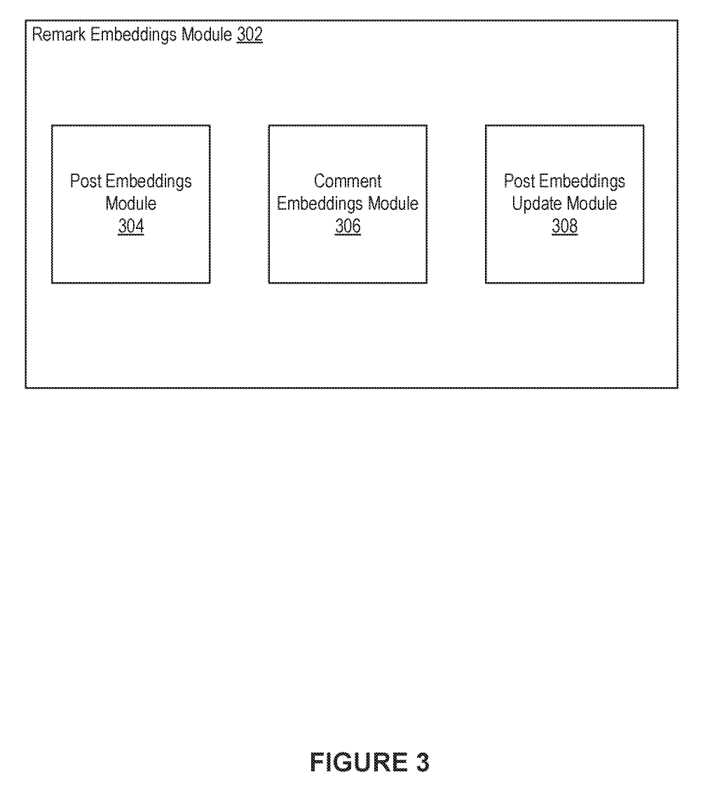

The remark embeddings module 108 can determine and provide embeddings corresponding to posts. Similarly, the remark embeddings module 108 can determine and provide embeddings corresponding to comments. Additional details regarding the remark embeddings module 108 are provided below with reference to FIG. 3.

The comment presentation module 110 can rank a set of comments which respond to a post. As an example, the ranking can be performed when the post is displayed to a user through an interface of a user device. For instance, the post may be displayed in response to the user accessing the entity (e.g., page, group, event) to which the post has been made. As further examples, the ranking can be performed periodically and/or when a new comment is made in reply to the post. In some embodiments, the ranking can be user-specific. That is, the ranking of comments can be personalized for a user. In other embodiments, the ranking can be generalized for all users of the social networking system.

Where the ranking is specific to a user, the comment presentation module 110 can calculate a personalization score for each comment of the post. The comment presentation module 110 can request an embedding for the post from the remark embeddings module 108. The comment presentation module 110 can also request an embedding for each comment of the post from the remark embeddings module 108. The comment presentation module 110 can request an embedding for the user from the engagement embeddings module 106. Next, the comment presentation module 110 can calculate a personalization score for each comment of the post as follows:

Cosine Similarity(π(P)+π(V),π(C)),

where π(P) corresponds to the embedding for the post, π(V) corresponds to the embedding for the user, π(C) corresponds to the embedding for a given comment, and Cosine Similarity( ) corresponds to a cosine similarity function. The sum can be a weighted sum. In some embodiments, the weights of the sum can be selected using a machine learning model.

Where the ranking is generalized for all users of the social networking system, the comment presentation module 110 can calculate a relevancy score for each comment of the post. The comment presentation module 110 can request an embedding for the post from the remark embeddings module 108. The comment presentation module 110 can also request an embedding for each comment of the post from the remark embeddings module 108. The comment presentation module 110 can then calculate a relevancy score for each comment of the post as follows:

Cosine Similarity(π(P),π(C)),

where π(P) corresponds to the embedding for the post, π(C) corresponds to the embedding for a given comment, and Cosine Similarity( ) corresponds to a cosine similarity function.

The comment presentation module 110 can rank the comments of the post according to the personalization scores or the relevancy scores depending on the implementation. Subsequently, the comment presentation module 110 can provide the post and the comments for presentation to the user. The post and the comments can be presented through a suitable interface of a user device. Moreover, the comments can be presented in a sequential order which reflects the rankings.

In some embodiments, the comment presentation module 110 can determine that certain comments do not satisfy some measure of quality. For example, in some embodiments, the comment presentation module 110 can identify comments having ranks that do not satisfy a threshold and/or comments that reflect low calculated cosine similarities (e.g., cosine similarities that do not satisfy some threshold). In general, any of these thresholds may be learned using machine learning. In some embodiments, the comment presentation module 110 can consider a cosine similarity of at or near negative one (−1) to be a low cosine similarity. Depending on the embodiment, comments that do not satisfy some measure of quality can be marked as spam, not presented to the user(s), or both.

FIG. 2 illustrates an example engagement embeddings module 202, according to an embodiment of the present disclosure. In some embodiments, the engagement embeddings module 106 of FIG. 1 can be implemented as the engagement embeddings module 202. As shown in FIG. 2, the engagement embeddings module 202 can include an entity embeddings module 204 and a user embeddings module 206.

The entity embeddings module 204 can generate an embedding for an entity (e.g., page, group, event, etc.). For example, the entity can include one or more posts and comments. The posts and comments can include media content items and text. The text can include words. In some embodiments, the entity embeddings module 204 can request an embedding for each word of the posts from the element embeddings module 104. In some embodiments, the entity embeddings module 204 can alternately or additionally request an embedding for each word of the comments from the element embeddings module 104. The entity embeddings module 204 can also request an embedding for each media content item of the posts from the element embeddings module 104. In some embodiments, the entity embeddings module 204 can alternately or additionally request an embedding for each media content item of the comments from the element embeddings module 104. The entity embeddings module 204 can then generate an embedding for the entity. In some embodiments, the embedding for the entity is generated using paragraph2vec. However, any generally known approach for creating paragraph embeddings may be used. In general, approaches for creating paragraph embeddings typically operate with paragraphs of terms, with the terms being represented by word embeddings. When creating an embedding for the entity, these terms can correspond to the words and the media content items of the posts and comments of the entity. These words and these media content items of the posts and comments of the entity can be represented by the embeddings received from the element embeddings module 104. The use of the embeddings received from the element embeddings module 104 can cause the embedding for the entity to exist within the same vector space as the natural language embeddings. After generating the embedding for the entity, the entity embeddings module 204 can save the embedding in the data store 112. Later, the entity embeddings module 204 can receive a request for an embedding for the entity. The entity embeddings module 204 can retrieve the embedding for the entity from the data store 112 and can satisfy the request by replying with the embedding. In some embodiments, the entity embeddings module 204 can regenerate the embedding for the entity. The regeneration can serve to have the embedding reflect changes to the entity. In some instances, changes to the entity may result from new posts and/or comments.

The user embeddings module 206 can generate an embedding for a user. A user can have interacted with various entities of the social networking system and/or with various other users of the social networking system. The user embeddings module 206 can access the data store 112 to determine the entities of the social networking system with which the user has interacted. In some embodiments, the user embeddings module 206 can also access the data store 112 to determine the other users of the social networking system with whom the user has interacted. The entities with which the user has interacted and/or other users which whom the user has interacted can reflect interests of the user.

In some embodiments, when generating an embedding for a first user, the user embeddings module 206 can request, from the entity embeddings module 204, an embedding for each entity with which the first user has interacted. The entity embeddings module 204 can satisfy the request by replying with embeddings for the entities. The user embeddings module 206 can then generate an embedding for the first user using paragraph2vec or any generally known approach for creating paragraph embeddings. Approaches for creating paragraph embeddings typically operate with paragraphs of terms, with the terms being represented by word embeddings. When creating an embedding for the first user, these terms can correspond to the entities of the social networking system with which the first user has interacted. The entities can be represented by the embeddings for entities received from the entity embeddings module 204. As noted, embeddings for entities exist within the same vector space as the discussed natural language embeddings. The use of the embeddings for entities received from the entity embeddings module 204 in creating the embedding for the first user can cause the embedding for the first user to also exist within the same vector space as the natural language embeddings.

In some embodiments, when generating the embedding for the first user, the paragraph embedding words can also correspond to other users of the social networking system with whom the first user has interacted. The other users can each be represented by an embedding which is generated by the user embeddings module 206 in the manner that the embedding for the first user is generated.

After generating the embedding for the first user, the user embeddings module 206 can save the embedding in the data store 112. Later, the user embeddings module 206 can receive a request for an embedding for the first user. Also, a request for an embedding for the first user received by the engagement embeddings module 202 can be routed to the user embeddings module 206. The user embeddings module 206 can retrieve the embedding for the first user from the data store 112 and can reply with the embedding. In some embodiments, the user embeddings module 206 can regenerate the embedding for the first user. The regeneration can serve to have the embedding reflect new interactions of the first user, such as new interactions with entities and/or other users.

FIG. 3 illustrates an example remark embeddings module 302, according to an embodiment of the present disclosure. In some embodiments, the remark embeddings module 108 of FIG. 1 can be implemented as the remark embeddings module 302. As shown in FIG. 3, the remark embeddings module 302 can include a post embeddings module 304, a comment embeddings module 306, and a post embeddings update module 308.

The post embeddings module 304 can generate an embedding for a post. As an example, the post embeddings module 304 can generate the embedding for the post when the post is introduced to the social networking system. When generating an embedding for the post, the post embeddings module 304 can request, from the engagement embeddings module 106, an embedding for a user who has made the post. The post embeddings module 304 can request, from the element embeddings module 104, an embedding for each word of the post. The post embeddings module 304 can also request, from the element embeddings module 104, an embedding for each media content item of the post. The post embeddings module 304 can then determine the embedding for the post as follows:

π(P)=λ·π(A)+γ_{w}·Σ_{wϵP}π(w)+γ_{mϵP}π′(m),

where π(P) can be the embedding for the post, π(A) can be the embedding for the user who has made the post, π(w) can be the embedding for a given one of the words of the post, Σ_{wϵP} can indicate that a summation be performed over the embeddings for all of the words of the post, π′(m) can be the embedding for a given one of the media content items of the post, Σ_{mϵP} can indicate that a summation be performed over the embeddings for all of the media content items of the post, and λ, γ_{w}, and γₘ can be weights. In some embodiments, the weights can be learned using a machine learning model which takes into account click-through data.

After generating the embedding for the post, the post embeddings module 304 can save the embedding in the data store 112. Later, the post embeddings module 304 can receive a request for an embedding for the post. The post embeddings module 304 can retrieve the embedding for the post from the data store 112 and can reply with the embedding.

The comment embeddings module 306 can generate an embedding for a comment. As an example, the comment embeddings module 306 can generate the embedding for the comment when the comment is introduced to the social networking system. The comment embeddings module 306 can request, from the engagement embeddings module 106, an embedding for a user who has made the comment. The comment embeddings module 306 can request, from the element embeddings module 104, an embedding for each word of the comment. The comment embeddings module 306 can also request, from the element embeddings module 104, an embedding for each media content item of the comment. The comment embeddings module 306 can then determine the embedding for the comment as follows:

π(C)=λ′·π(B)+γ′_{w}ΣΣ_{wϵc}π(W)+γ′ₘ·Σ_{mϵc}π′(m),

where π(C) can be the embedding for the comment, π(B) can be the embedding for the user who has made the comment, π(w) can be the embedding for a given one of the words of the comment, Σ_{wϵc} can indicate that a summation be performed over the embeddings for all of the words of the comment, π(m) can be the embedding for a given one of the media content items of the comment, Σ_{mϵc} can indicate that a summation be performed over the embeddings for all of the media content items of the comment, and λ′, γ_{w}′, and γₘ′ can be weights. In some embodiments, the weights can be learned using a machine learning model which takes into account click-through data.

After generating the embedding for the comment, the comment embeddings module 306 can save the embedding in the data store 112. Later, the comment embeddings module 306 can receive a request for an embedding for the comment. The comment embeddings module 306 can retrieve the embedding for the comment from the data store 112 and can reply with the embedding.

The post embeddings update module 308 can update an embedding for a post. As an example, the post embeddings update module 308 can update an embedding for a post after a comment which replies to the post is introduced to the social networking system. The post embeddings update module 308 can then determine the updated embedding for the post as follows:

π(P)=π_{current}(P)+π(C),

where π(P) can be the updated embedding for the post, π_{current}(P) can be the current embedding for the post, and π(C) can be the embedding for the comment. The sum can be a weighted sum. In some embodiments, the weights can be learned using a machine learning model which takes into account user behavior in the social networking system.

In some embodiments, a normalization can be applied in updating the embedding for the post based on a comment. As one illustration, the post embeddings update module 308 can perform a calculation using the equation:

$$π ( P ) = \frac{n}{n + 1} \cdot {π}_{current} ( P ) + \frac{1}{n + 1} \cdot π ( C ) ,$$

where π(P) can be the updated embedding for the post, π_{current}(P) can be the current embedding for the post, π(C) can be the embedding for the comment, and n can be the total number of other comments which have been made to the post prior to the introduction of the comment. The use of

$$\frac{n}{n + 1} and \frac{1}{n + 1}$$

can cause comments which are introduced later to have a smaller effect on updating the embedding for the post than comments which are introduced earlier. The sum can be a weighted sum. In some embodiments, the weights can be learned using a machine learning model which takes into account user behavior in the social networking system.

After updating the embedding for the post, the post embeddings update module 308 can save the updated embedding in the data store 112. The post embeddings module 304 can subsequently receive a request for an embedding for the post. The post embeddings module 304 can then retrieve the updated embedding for the post from the data store 112 and can reply with the updated embedding. In some embodiments, updating of posts might not be performed. In such embodiments, the post embeddings update module 308 might not be implemented. Moreover, in some embodiments, where the comment presentation module 110 determines that a comment does not satisfy some measure of quality, the post embeddings update module 308 can be instructed to not update the embedding for the post with respect to the comment.

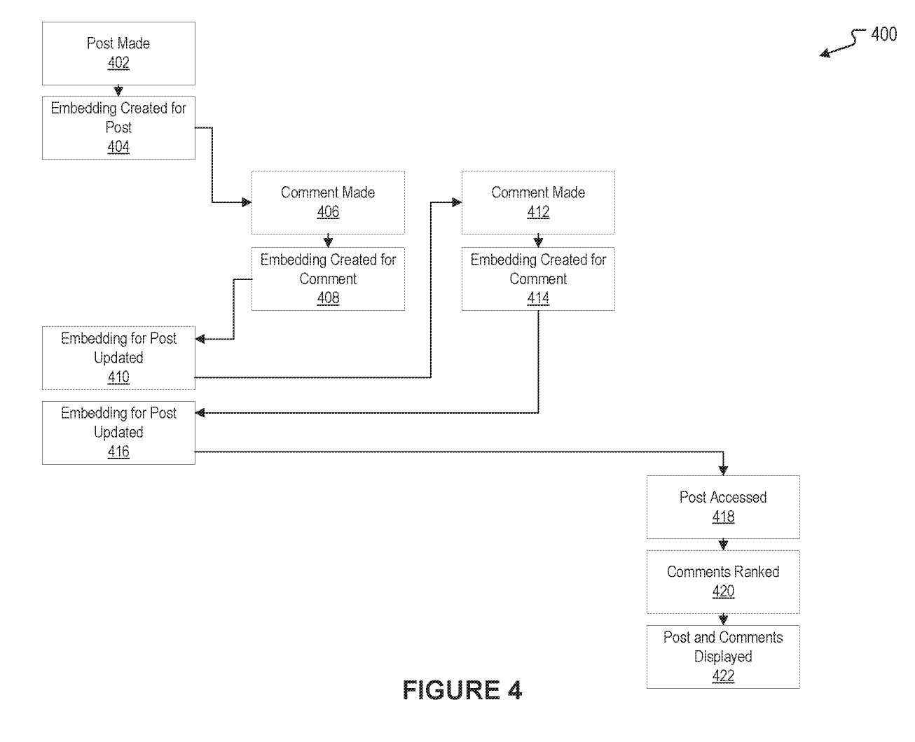

FIG. 4 illustrates an example functional block diagram 400, according to an embodiment of the present disclosure. The example functional block diagram 400 illustrates a flow associated with ranking comments using neural embeddings, according to an embodiment of the present disclosure.

At block 402, a first user can make a post to an entity of a social networking system. As examples, the entity can be a page, a group, or an event. At block 404, an embedding can be generated for the post. The generation of the embedding for the post can be based on an embedding for the first user, embeddings for words in the post, and/or embeddings for media content items included in the post. At block 406, a second user can make a comment in reply to the post. At block 408, an embedding can be generated for the comment made by the second user. The generation of the embedding for the comment can be based on an embedding for the second user, embeddings for words of the comment, and/or embeddings for media content items of the comment. At block 410, the embedding for the post can be updated based on the embedding for the comment made by the second user. At block 412, a third user can make a comment in reply to the post. At block 414, an embedding can be generated for the comment made by the third user. The generation of the embedding for the comment can be based on an embedding for the third user, embeddings for words of the comment, and/or embeddings for media content items of the comment. At block 416, the embedding for the post can be updated based on the embedding for the comment made by the third user. At block 418, a viewing user can access the post through a social networking system. In general, the viewing user may be any user accessing the post including, for example, the first user, the second user, and/or the third user. At block 420, the comments of the post can be ranked. As one example, the ranking of the comments can include calculating a personalization score for each comment. The calculation of the personalization score for a given comment can include calculating a cosine similarity between: (1) the embedding for the post and an embedding for the viewing user and (2) an embedding for the comment. As another example, the ranking of the comments can include calculating a relevancy score for each comment. The calculation of the relevancy score for a given comment can include calculating a cosine similarity between the embedding for the post and an embedding for the comment. At block 422, the post and the comments can be displayed to the viewing user. The comments can be displayed in an order which reflects the calculated personalization scores or the calculated relevancy scores.

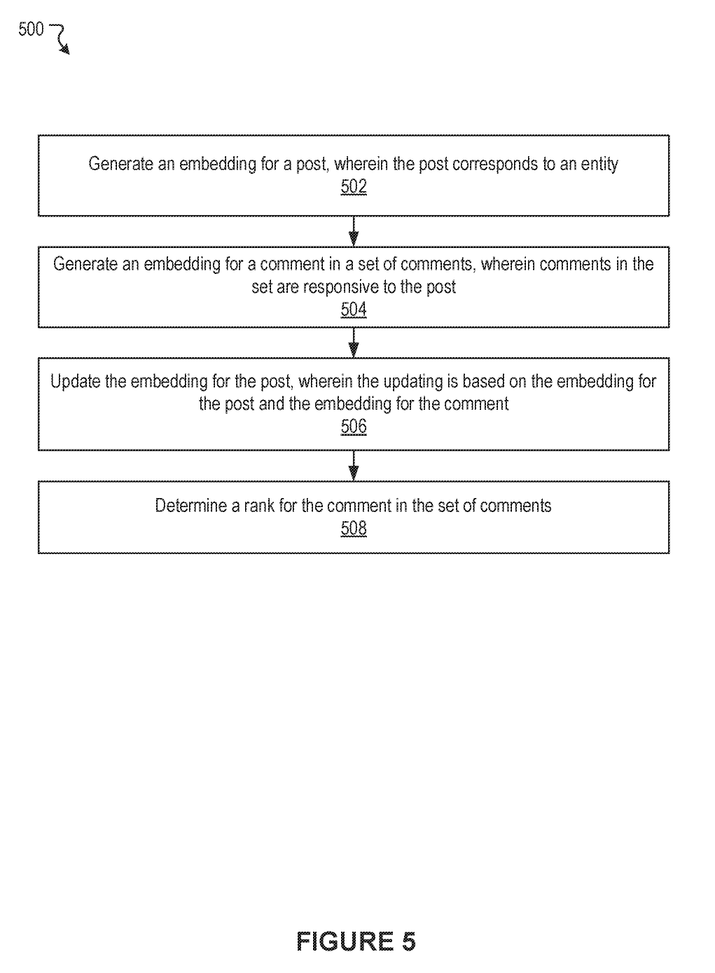

FIG. 5 illustrates an example process 500, according to various embodiments of the present disclosure. It should be appreciated that there can be additional, fewer, or alternative steps performed in similar or alternative orders, or in parallel, within the scope of the various embodiments discussed herein unless otherwise stated.

At block 502, the example process 500 can generate an embedding for a post, wherein the post corresponds to an entity. At block 504, the process can generate an embedding for a comment in a set of comments, wherein comments in the set are responsive to the post.

Then, at block 506, the process can update the embedding for the post, wherein the updating is based on the embedding for the post and the embedding for the comment. At block 508, the process can determine a rank for the comment in the set of comments.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), macOS, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects another user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music, or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list.” External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a comment ranking module 646. The comment ranking module 646 can, for example, be implemented as the comment ranking module 102 of FIG. 1. As discussed previously, it should be appreciated that there can be many variations or other possibilities.

### Hardware Implementation

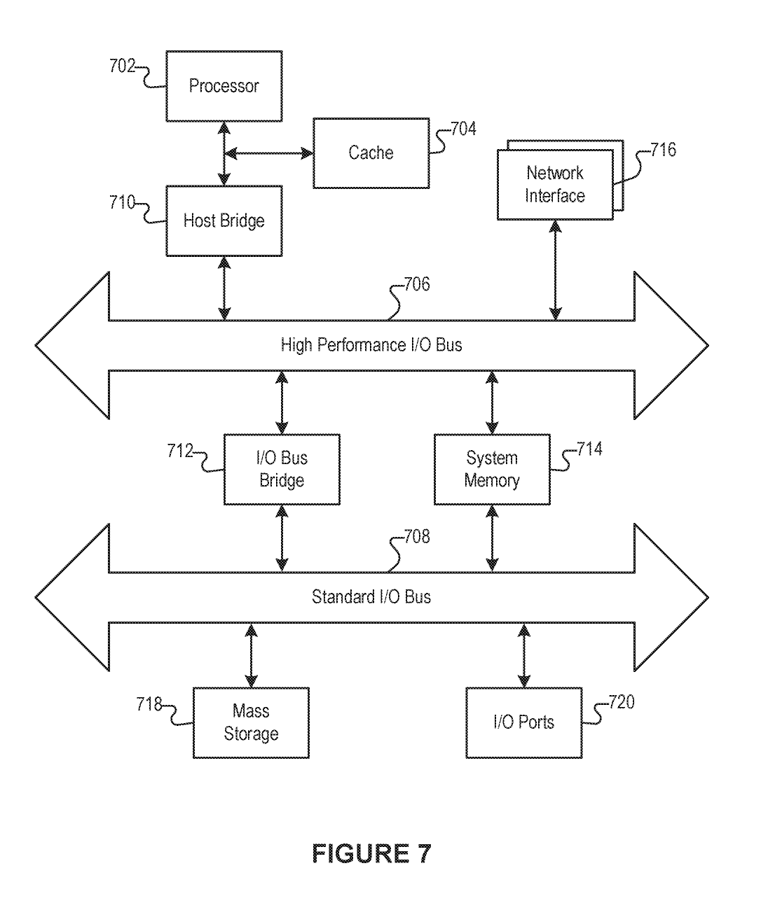

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs.” For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “one series of embodiments,” “some embodiments,” “various embodiments,” or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
generating, by a computing system, an embedding for a post, wherein the post corresponds to an entity;
generating, by the computing system, an embedding for a comment in a set of comments, wherein comments in the set are responsive to the post;
updating, by the computing system, the embedding for the post, wherein the updating is based on the embedding for the post and the embedding for the comment; and
determining, by the computing system, a rank for the comment in the set of comments.

2. The computer-implemented method of claim 1, further comprising:
determining, by the computing system, a relevancy score for the comment, wherein the relevancy score is based on the embedding for the post and the embedding for the comment, and wherein the rank for the comment is determined based at least in part on the relevancy score.

3. The computer-implemented method of claim 1, further comprising:
determining, by the computing system, a personalization score for the comment, wherein the personalization score is based on the embedding for the post, an embedding for a user to whom the post is to be presented, and the embedding for the comment, and wherein the rank for the comment is determined based at least in part on the personalization score.

4. The computer-implemented method of claim 1, wherein the embedding for the post is generated based on an embedding for a user who has made the post, embeddings for words in the post, and embeddings for media content items in the post.

5. The computer-implemented method of claim 1, wherein the embedding for the comment is generated based on an embedding for a user who has made the comment, embeddings for words of the comment, and embeddings for media content items of the comment.

6. The computer-implemented method of claim 1, further comprising:
generating, by the computing system, an embedding for a user, wherein the embedding for the user is generated based at least in part on embeddings for entities with which the user has interacted.

7. The computer-implemented method of claim 6, wherein the generating the embedding for the user includes generating a paragraph embedding.

8. The computer-implemented method of claim 1, further comprising:
generating, by the computing system, an embedding for the entity, wherein the embedding for the entity is generated based at least in part on embeddings for words of posts and comments of the entity, and embeddings for media content items of posts and comments of the entity.

9. The computer-implemented method of claim 1, wherein the determining the rank for the comment comprises determining a cosine similarity.

10. The computer-implemented method of claim 1, further comprising:
providing, by the computing system, a media content item to a machine learning model;
receiving, by the computing system, a prediction of words appearing with the media content item from the machine learning model; and
generating, by the computing system, an embedding for the media content item, wherein the embedding for the media content item is generated based at least in part on embeddings for the predicted words.

11. A system comprising:
at least one processor; and
a memory storing instructions that, when executed by the at least one processor, cause the system to perform:
generating an embedding for a post, wherein the post corresponds to an entity;
generating an embedding for a comment in a set of comments, wherein comments in the set are responsive to the post;
updating the embedding for the post, wherein the updating is based on the embedding for the post and the embedding for the comment; and
determining a rank for the comment in the set of comments.

12. The system of claim 11, wherein the instructions, when executed by the at least one processor, further cause the system to perform:
determining a relevancy score for the comment, wherein the relevancy score is based on the embedding for the post and the embedding for the comment, and wherein the rank for the comment is determined based at least in part on the relevancy score.

13. The system of claim 11, wherein the instructions, when executed by the at least one processor, further cause the system to perform:
determining a personalization score for the comment, wherein the personalization score is based on the embedding for the post, an embedding for a user to whom the post is to be presented, and the embedding for the comment, and wherein the rank for the comment is determined based at least in part on the personalization score.

14. The system of claim 11, wherein the embedding for the post is generated based on an embedding for a user who has made the post, embeddings for words in the post, and embeddings for media content items in the post.

15. The system of claim 11, wherein the embedding for the comment is generated based on an embedding for a user who has made the comment, embeddings for words of the comment, and embeddings for media content items of the comment.

16. A non-transitory computer-readable storage medium including instructions that, when executed by at least one processor of a computing system, cause the computing system to perform a method comprising:
generating an embedding for a post, wherein the post corresponds to an entity;
generating an embedding for a comment in a set of comments, wherein comments in the set are responsive to the post;
updating the embedding for the post, wherein the updating is based on the embedding for the post and the embedding for the comment; and
determining a rank for the comment in the set of comments.

17. The non-transitory computer-readable storage medium of claim 16, wherein the instructions, when executed by the at least one processor of the computing system, further cause the computing system to perform:
determining a relevancy score for the comment, wherein the relevancy score is based on the embedding for the post and the embedding for the comment, and wherein the rank for the comment is determined based at least in part on the relevancy score.

18. The non-transitory computer-readable storage medium of claim 16, wherein the instructions, when executed by the at least one processor of the computing system, further cause the computing system to perform:
determining a personalization score for the comment, wherein the personalization score is based on the embedding for the post, an embedding for a user to whom the post is to be presented, and the embedding for the comment, and wherein the rank for the comment is determined based at least in part on the personalization score.

19. The non-transitory computer-readable storage medium of claim 16, wherein the embedding for the post is generated based on an embedding for a user who has made the post, embeddings for words in the post, and embeddings for media content items in the post.

20. The non-transitory computer-readable storage medium of claim 16, wherein the embedding for the comment is generated based on an embedding for a user who has made the comment, embeddings for words of the comment, and embeddings for media content items of the comment.
